(19) United States
(12) Patent Application Publication
(10) Pub. No.: US 2026/0242152 A1
(43) Pub. Date: Aug. 20, 2026

(54) CONVEYOR PULLEY MONITORING SYSTEMS, METHODS AND APPARATUS

(71) Applicant: Superior Industries, Inc., Morris, MN (US)

(72) Inventors: Paulo Batagini, Rafard (BR); Danilo Bibancos, Rafard (BR)

(21) Appl. No.: 19/159,452

(22) PCT Filed: Feb. 23, 2024
(86) PCT No.: PCT/US24/17133

§ 371 Date: Aug. 25, 2025

Related U.S. Application Data
(60) Provisional application No. 63/486,810, filed on Feb. 24, 2023.

(51) Int. Cl. B65G 43/02; B65G 23/04

(52) U.S. Cl. CPC B65G 43/02; B65G 23/04; B65G 2203/0275; B65G 2203/042; B65G 2207/48

(57) ABSTRACT

Conveyor pulleys and pulley wear monitoring systems and methods are provided for monitoring wear of the pulley, e.g. a belt support such as pulley lagging. Some embodiments comprise a conductive portion extending at least partly through the belt support (e.g., a conductive segment such as a conductive rubber segment).

### BACKGROUND

Conveyor pulleys support, align, redirect or otherwise interact with the endless belt of a conveyor. Sensors have been used to measure various environmental and operational criteria of belt conveyors.

### BRIEF DESCRIPTION OF THE DRAWINGS

FIG. 1 is a perspective view of an embodiment of a conveyor pulley.

FIG. 2 is another perspective view of the conveyor pulley of FIG. 1.

FIG. 3 is a sectional view of the conveyor pulley of FIG. 1.

FIG. 4 is a perspective view of another embodiment of a conveyor pulley.

FIG. 5 is another perspective view of the conveyor pulley of FIG. 4.

FIG. 6 is a perspective view of still another embodiment of a conveyor pulley.

FIG. 7 is a schematic illustration of an embodiment of a wear monitoring system.

FIG. 8 is a schematic illustration of an embodiment of method of monitoring pulley wear.

### DESCRIPTION

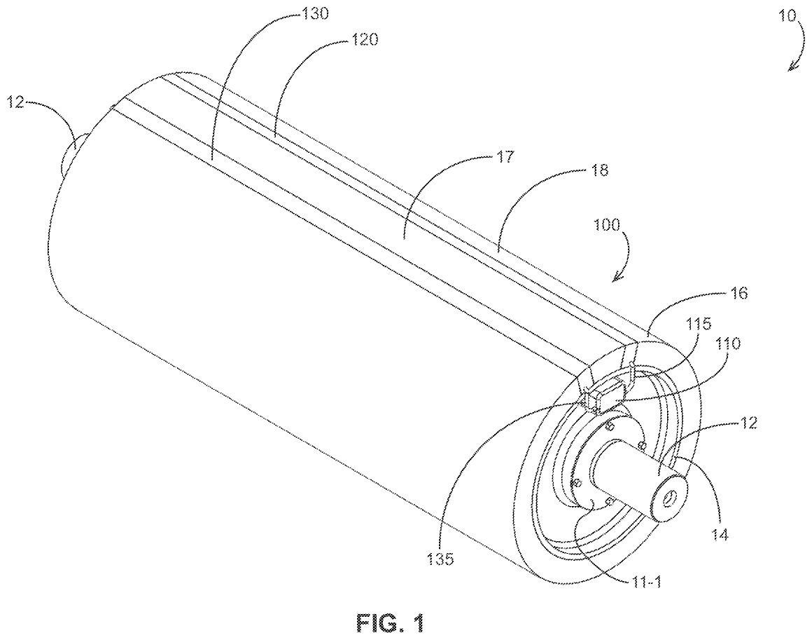

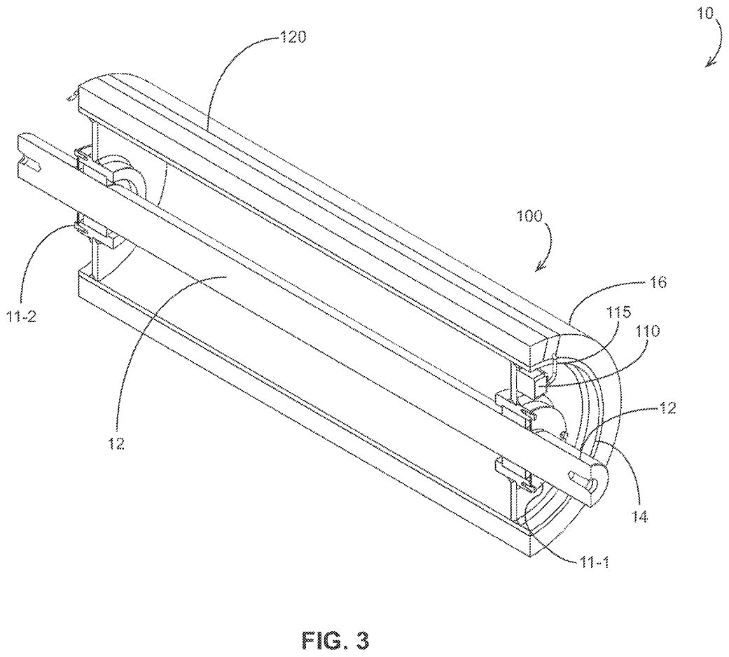

Referring to the drawings, wherein like reference numerals designate identical or corresponding parts throughout the several views, FIGS. 1-3 illustrate an embodiment of a conveyor pulley 10 rollingly supported on a shaft 12. The shaft 12 is optionally configured to be supported on a conveyor (e.g., at the head end thereof, at the tail end thereof, at an intermediate location, etc.). The pulley 10 optionally comprises a body 14 (e.g., cylindrical body, drum, etc.). The body 14 is optionally rollingly supported on the shaft 12 by first and second rolling supports 11-1, 11-2 (e.g., bearing assemblies, etc.). A generally cylindrical belt support 16 (e.g., pulley lagging, etc.) is optionally circumferentially arranged and supported on the body 14.

In some embodiments the pulley 10 is provided with a wear monitoring system 100. The wear monitoring system 100 optionally comprises a first conductive element 120 and a second conductive element 130. The first and second elements 120, 130 optionally at least partially comprise a conductive material which is optionally resilient (e.g., conductive rubber, etc.). The first and second elements 120, 130 optionally extend at least part of the length of the belt support 16. In various embodiments, the elements extend along the entire length, along an intermediate portion of the length, along a left-hand portion of the length, along a right-hand portion of the length, etc. The elements 120, 130 optionally comprise portions of the belt support 16. The elements 120, 130 are optionally electrically isolated from one another, e.g., by a first intermediate portion 17 of the belt support 16 and/or a second intermediate portion 18 of the belt support 16. The first and second intermediate portions 17, 18 optionally comprise a resilient material (e.g., rubber, plastic). The elements 120,130 optionally at least partially support the conveyor belt (e.g., cooperatively with portions 17, 18). The elements 120, 130 are optionally of the same radial thickness as the portions 17, 18. The first and second intermediate portions 17, 18 optionally at least partially comprise a less conductive material (e.g., non-conductive material) than the material of elements 120, 130. The elements 120, 130 optionally extend substantially (e.g., more than halfway, entirely, etc.) across a width of the body 14. In some embodiments, the elements 120, 130 each have a radial inner surface contacting the body 14 and a radial outer surface disposed to contact a conveyor belt. In yet a further embodiment, at least one of the elements 120, 130 has a radial height (i.e., as measured from the radial inner surface to the radial outer surface) less than an overall radial height of belt support 16.

The wear monitoring system 100 optionally comprises an electrical module 110 (optionally supported on body 14). The module 110 (e.g., a resistance sensor thereof) is optionally in electrical communication with a first end of first portion 120 (e.g., via a wire 115). The module 110 (e.g., a processor thereof) is optionally in electrical communication with a first end of second portion 130 (e.g., via a wire 135). A second end of first portion 120 is optionally in electrical communication with a second end of second portion 130 (e.g., via a wire 125).

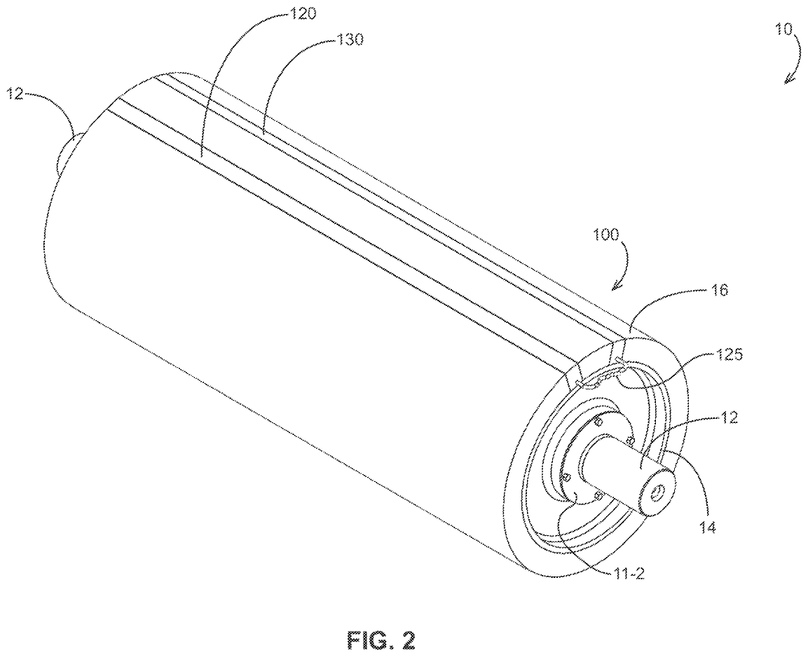

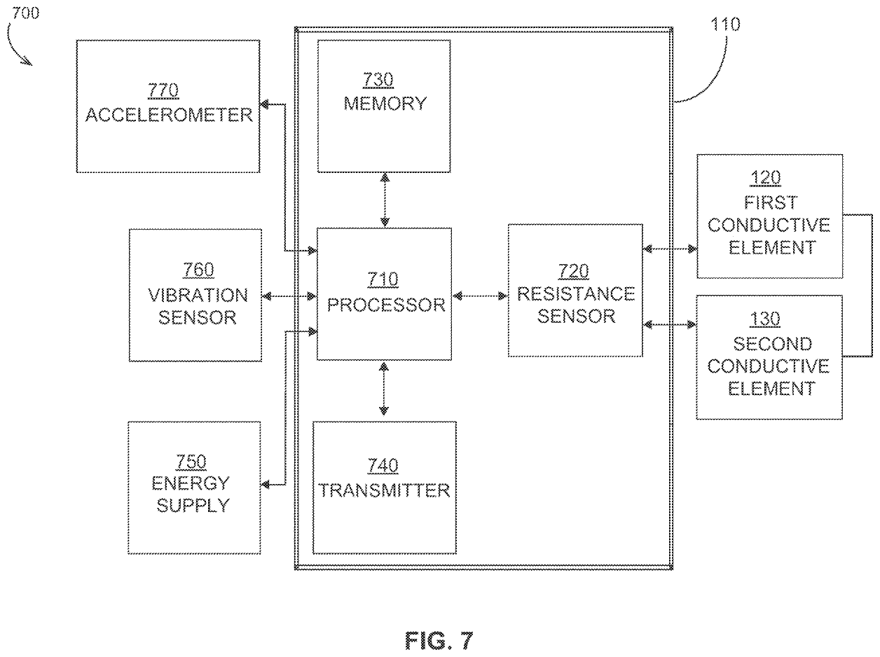

Referring to FIG. 7, the module 110 optionally supports and/or contains one or more components of an electrical system 700. The electrical system 700 optionally comprises a processor 710 (e.g., microprocessor) in data communication with a resistance sensor 720 (e.g., device and/or circuitry configured to measure a resistance, e.g., a Wheatstone bridge, current measurement device, voltage measurement device, resistometer, etc.). The resistance sensor 720 is optionally in electrical communication with the first conductive element 120 and the second conductive element 130 (e.g., in series, as illustrated in FIGS. 1 and 2, in parallel, etc.). The processor 710 is optionally in data communication with a memory 730. The processor 710 is optionally in data communication with a transmitter 740 (e.g., a wireless transmitter) which is optionally in data communication with one or more of a mobile computing device, a cloud-based server via a cellular connection, etc. The processor 710 is optionally in data communication with a speed sensor such as an encoder, accelerometer or the like that is configured to measure the speed and/or number of rotations of the pulley 10. The speed sensor is herein embodied as an accelerometer 770. The processor 710 is optionally in data communication with a vibration sensor 760 (e.g., accelerometer, microphone, noise sensor, etc.) configured to measure a vibration of the pulley 10 (e.g., of the shaft 12 and/or body 14). One or more elements of the electrical system 700 including processor 710 are in optionally in electrical communication with an energy supply (e.g., battery, generator, generator powered by rotation of the pulley 10, etc.).

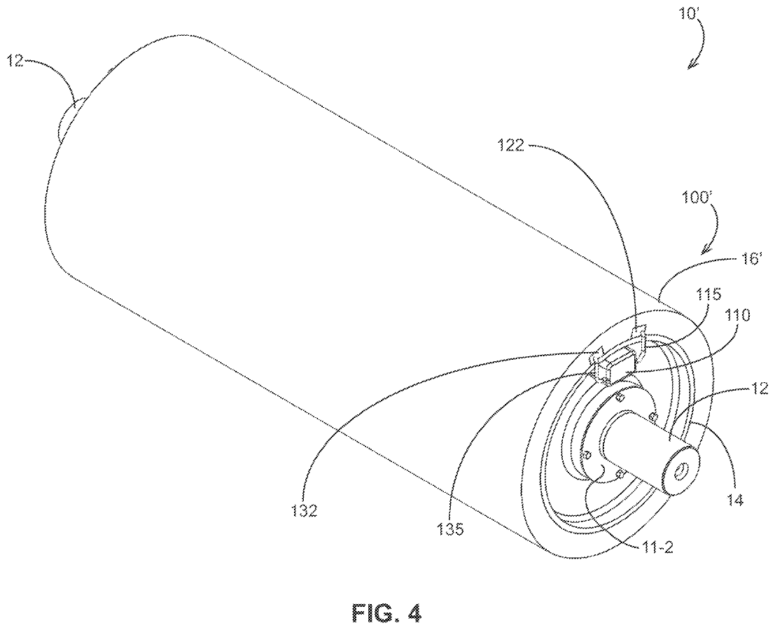

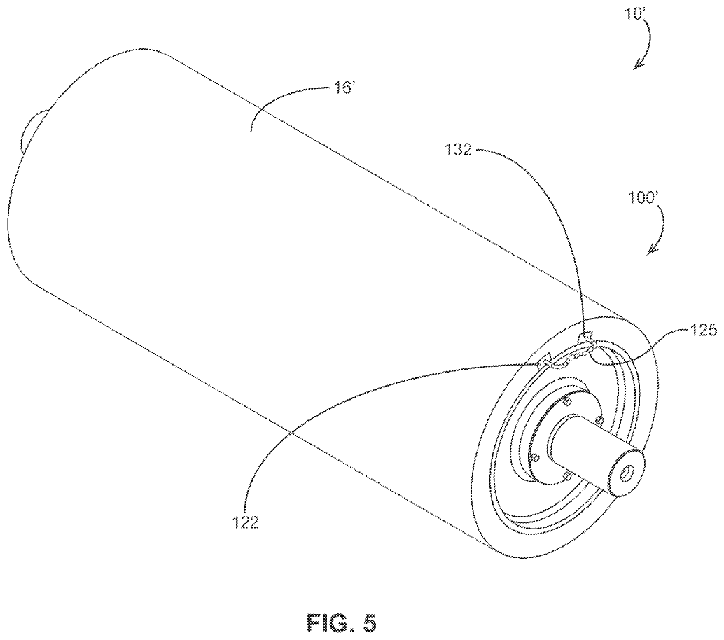

Referring to FIGS. 4 and 5, another embodiment of a pulley 10′ provided with another embodiment of a wear monitoring system 100′ is illustrated. The wear monitoring system 100′ is optionally similar or identical to the wear monitoring system 100 except as described herein. The wear monitoring system 100′ optionally comprises modified elements 122, 132 one or both of which optionally radially extend only partially from the body 14 toward the external circumference of a modified belt support 16′. The modified belt support 16′ optionally includes one or more portions disposed radially between one or both elements 122, 132 and the external circumference of the modified belt support 16′. The modified elements 122, 132 optionally extend substantially (e.g., more than halfway, entirely, etc.) across the width of the body 14.

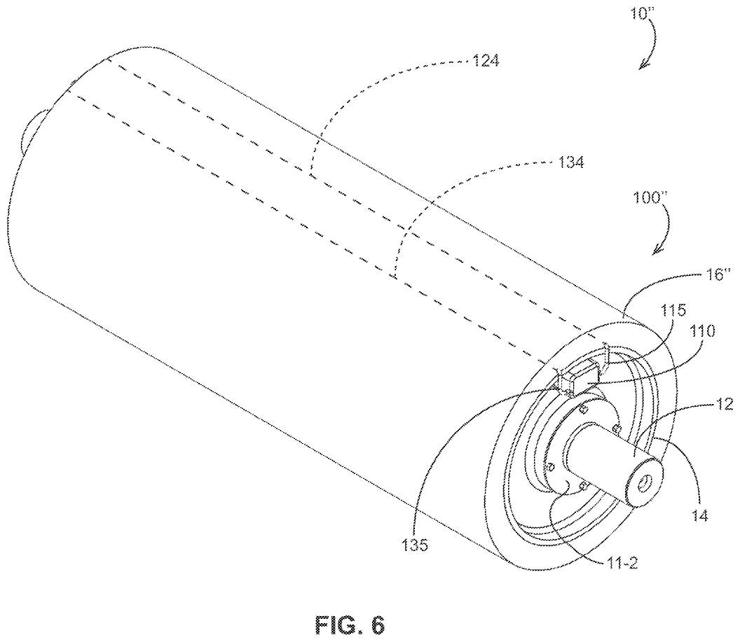

Referring to FIG. 6, another embodiment of a pulley 10″ provided with another embodiment of a wear monitoring system 100″ is illustrated. The wear monitoring system 100″ is optionally similar or identical to the wear monitoring system 100 except as described herein. The wear monitoring system 100″ optionally includes wire segments 124, 134 in place of (or in addition to) elements 120, 130, respectively. Wire segments 124, 134 are optionally at least partially or completely embedded in a modified belt support 16″. The wire segments 124, 134 are optionally connected at an end distal from the module 110 by wire 125. In other embodiments, the wire segments 124, 134 are connected by a wire segment at least partially embedded in the support 16″. The wire segments 124, 134 optionally comprise portions of a single wire or may comprise separate wires according to various embodiments.

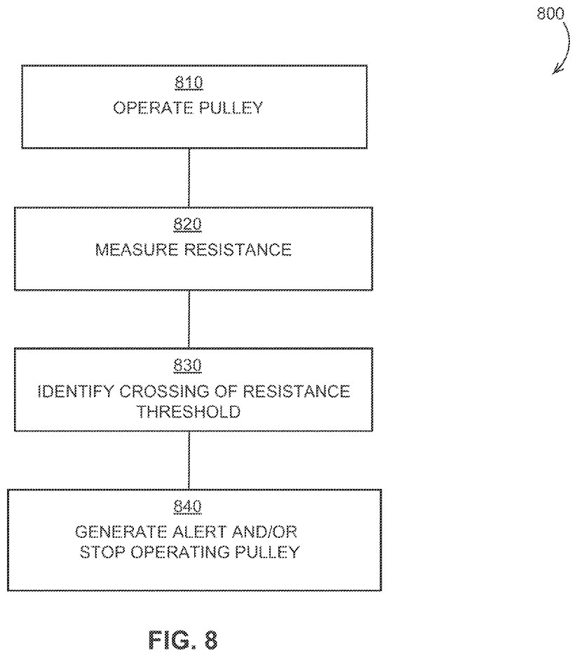

Referring to FIG. 8, an embodiment of a method 800 of monitoring wear of a pulley belt support (e.g., lagging) is illustrated. The method 800 is optionally carried out using a wear monitoring system 100 (or system 100′ or system 100″). At step 810, the pulley 10 (or pulley 10′ or pulley 10″, etc.) is operated (e.g., by driving a motor, etc.). Operation of the pulley results in the pulley rolling while supporting the conveyor belt, gradually causing wear of the support 16 (or support 16′ or support 16″, etc.). While continuing to operate the pulley, at step 820 the system measures a resistance associated with a conductive element (and/or conductivity or other electrical criterion or other criterion) such as the overall resistance of an electrical path including the elements 120, 130 (or elements 122, 132; or segments 124, 134). At step 830, the system optionally identifies that the resistance or other criterion has crossed a predetermined threshold value (e.g., the resistance has decreased below a threshold value, has increased above a threshold value, etc.). It should be appreciated that as non-limiting examples, a change in resistance value of a conductive rubber segment may correspond to wear of the segment and that a change in resistance value of a conductive path including a wire segment may correspond to degradation of the wire segment. At step 840, the system 100 optionally carries out one or more actions in response to step 830, such as generating an alert to be displayed to a user (e.g., on a mobile device, desktop computing device, alarm light, etc. in data communication with system 100) and/or sending a command to stop operating the pulley (e.g., to a pulley drive motor in data communication with system 100).

Any ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A wear monitoring system for a conveyor pulley, the conveyor pulley comprising a body and a belt support, the wear monitoring system comprising:
an electrical module supported on the body;
a resistance sensor supported on said electrical module; and
a first conductive element comprising a portion of the belt support, said first conductive element being in electrical communication with said resistance sensor.

2. The wear monitoring system of claim 1, further comprising:
a second conductive element comprising a portion of the belt support, said second conductive element being in electrical communication with said resistance sensor.

3. The wear monitoring system of claim 1, further comprising:
a memory supported on said electrical module, said memory being in electrical communication with said resistance sensor;
a processor supported on said electrical module, said processor being in electrical communication with said resistance sensor; and
a transmitter supported on said electrical module, said memory being in electrical communication with said resistance sensor.

4. The wear monitoring system of claim 1, further comprising:
a processor in electrical communication with said resistance sensor; and
a speed sensor in data communication with said processor.

5. The wear monitoring system of claim 4, wherein said speed sensor comprises an accelerometer.

6. The wear monitoring system of claim 1, further comprising:
a processor in electrical communication with said resistance sensor;
a vibration sensor in data communication with said processor.

7. A conveyor pulley for supporting a conveyor belt, comprising:
a body configured to be rollingly supported on a shaft;
a belt support supported on said body, said belt support being circumferentially arranged about said body; and
a wear monitoring system comprising:
an electrical module supported on said body;
a resistance sensor supported on said electrical module; and
a first conductive element comprising a first portion of said belt support, said first conductive element being in electrical communication with said resistance sensor.

8. The conveyor pulley of claim 7, wherein said first conductive element extends across a width of said belt support.

9. The conveyor pulley of claim 7, further comprising:
a second conductive element comprising a second portion of said belt support, said second conductive element being in electrical communication with said resistance sensor; and
an intermediate portion of said belt support disposed between said first portion and said second portion.

10. The conveyor pulley of claim 9, wherein said second conductive element extends across a width of said belt support.

11. The conveyor pulley of claim 10, wherein said first conductive element extends across a width of said belt support.

12. The conveyor pulley of claim 9, wherein a first end of said first conductive element is in electrical communication with said resistance sensor.

13. The conveyor pulley of claim 12, wherein a second end of said first conductive element is in electrical communication with a second end of said second conductive sensor.

14. The conveyor pulley of claim 13, wherein said a first end of said second conductive element is in electrical communication with said resistance sensor.

15. The conveyor pulley of claim 7, wherein said first conductive element has a radially inner surface contacting said body.

16. The conveyor pulley of claim 7, wherein said first conductive element has a radially outer surface disposed to contact a conveyor belt.

17. The conveyor pulley of claim 7, wherein said first conductive element has a radially inner surface contacting said body and further comprising a second conductive element having a radially inner surface contacting said body.

18. The conveyor pulley of claim 7, wherein at least one of said first conductive element and a second conductive element has a radial height which is less than an overall radial height of said belt support.

19. A method of monitoring wear of a conveyor pulley, the conveyor pulley comprising a body and a belt support, the method comprising:
operating the conveyor pulley;
measuring a resistance associated with a conductive element comprising a portion of the belt support;
identifying a crossing of a resistance threshold by said measured resistance; and
generating an alert based on said crossing of said resistance threshold.

20. The method of claim 19, further comprising:
stopping operation of the conveyor pulley based on said crossing of said resistance threshold, wherein said resistance threshold is related to a thickness of the conductive element.
